(19) United States
(12) Patent Application Publication
(10) Pub. No.: US 2025/0283579 A1
(43) Pub. Date: Sep. 11, 2025

(54) DEVICE FOR STORING AND SUPPLYING CRYOGENIC FLUID, IN PARTICULAR LIQUEFIED HYDROGEN

(71) Applicant: L'Air Liquide, Societe Anonyme pour l'Etude et l’Exploitation des Procedes Georges Claude, Paris (FR)

(72) Inventor: Thomas FAYER, Sassenage (FR)

(73) Assignee: L'Air Liquide, Societe Anonyme pour l'Etude et l’Exploitation des Procedes Georges Claude, Paris (FR)

(21) Appl. No.: 18/289,761

(22) PCT Filed: Mar. 31, 2022
(86) PCT No.: PCT/EP2022/058561

§ 371 Date: Sep. 26, 2024

(30) Foreign Application Priority Data
May 7, 2021 (FR) FR 2104825

(51) Int. Cl. F17C 7/02; F17C 13/00

(52) U.S. Cl. CPC F17C 7/02; F17C 13/001; F17C 2201/0109; F17C 2201/035; F17C 2203/0391; F17C 2203/0629; F17C 2221/012; F17C 2223/0161; F17C 2223/041; F17C 2223/046; F17C 2227/0135; F17C 2227/0302; F17C 2250/0626; F17C 2260/016; F17C 2260/02; F17C 2260/056

(57) ABSTRACT

A device for storing and supplying cryogenic fluid, in particular liquefied hydrogen, comprising a tank delimiting a fluid-storage volume, the tank comprising a set of plates intended to limit or guide the movement of fluid in the tank, the set of plates comprising a plurality of first plates spaced vertically and extending in a horizontal direction when the tank is in a use position, characterized in that the set of plates further comprises one or more second plates extending in a vertical direction when the tank is in a use position, and connected to the first plates, the device further comprising a withdrawal circuit comprising a liquid-withdrawal pipe having a first end connected to a lower portion of the tank and a second end intended to be connected to a member for receiving the fluid, the liquid-withdrawal pipe comprising a pump, the device further comprising a system for pressurizing the tank that comprises a fluid-pressurizing pipe connecting the lower and upper parts of the tank and provided with a fluid-heating member configured to tap off some liquid, beat it and reinject it into the tank.

The invention relates to a device for storing and supplying cryogenic fluid.

More particularly, the invention relates to a device for storing and supplying cryogenic fluid, in particular liquefied hydrogen, comprising a tank delimiting a fluid storage volume, the tank comprising a set of plates which are designed to limit or guide the displacement of fluid in the tank, the set of plates comprising a plurality of first plates which are spaced vertically, and extend in a horizontal direction when the tank is in the position of use.

Storage of hydrogen in liquefied form associated with a pump is a solution for storing and supplying hydrogen in numerous applications.

The cryogenic pumps used can be subject to intake cavitation problems (bubbles in the flow). This problem is all the greater for light cryogenic fluids, where the molecule is close to the saturating vapor point, and does not benefit from a substantial manometric lift (low density) in order to ensure good differential between the total absolute pressure of the liquid and its saturating vapor pressure (“NPSH” for “Net Positive Suction Head”).

Various solutions are known for solving this problem, for example increasing the manometric lift upstream from the pump (vertical tank). Other solutions consist of adding a source storage pressurization device, or adding a phase separator pot upstream from the pump.

The known solutions are not always satisfactory.

An objective of the present invention is to eliminate some or all of the above-described disadvantages of the prior art.

For this purpose, the device according to the invention, which moreover is in conformity with the generic definition given by the above preamble, is substantially characterized in that the set of plates also comprise one or a plurality of second plates which extend in a vertical direction when the tank is in the position of use, and is/are connected to the first plates, the device also comprising a drawing-off circuit comprising a liquid drawing-off duct having a first end which is connected to a lower portion of the tank, and a second end which is designed to be connected to a unit for receipt of the fluid, the liquid drawing-off duct comprising a pump, the device also comprising a system for pressurization of the tank comprising a duct for pressurization of fluid which connects the lower and upper parts of the tank, and being provided with a fluid heating unit which is configured to collect liquid, heat it, and re-inject it into the tank.

In addition, embodiments of the invention can comprise one or a plurality of the following characteristics:
the device comprises a plurality of second plates which are spaced in the horizontal direction;
the first plates extend over most of the horizontal cross-section of the volume of the tank, and are spaced from the wall which forms the tank over at least part of their periphery;
the vertical spacing of the first plates increases from the top to the bottom of the tank;
the second plate(s) extend(s) over most of the vertical cross-section of the volume of the tank, and is/are spaced from the wall which forms the tank over at least part of their periphery;
the plates have a thickness of between 0.1 mm and 1 mm;
the plates are composed of at least one of the materials from out of: plastics, PTFE, PCTFE, aluminum, stainless steel, austenitic steel, which in particular are compatible with hydrogen;
at least some of the plates comprise orifices;
the set of plates is secured rigidly on the tank, for example by at least one from out of: welding, clamping, screwing.

The invention can also relate to any alternative device comprising any combination of the method or characteristics above or below within the context of the claims.

Further particular features and advantages will become apparent upon reading the following description, which is provided with reference to the figures, in which:

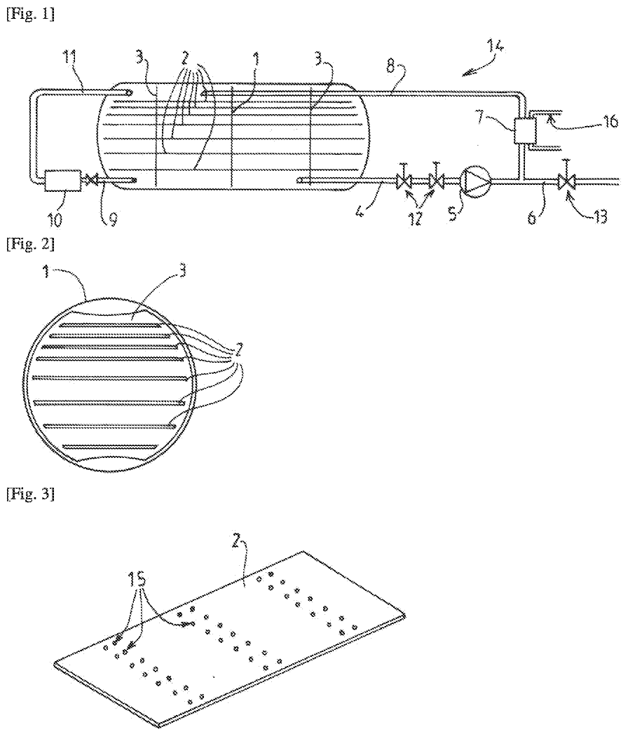

FIG. 1 represents a longitudinal, schematic, partial, side view in cross-section illustrating a first embodiment of the device according to the invention;

FIG. 2 represents a transverse, schematic, partial view in cross-section of the aforementioned device;

FIG. 3 represents a schematic, partial view in perspective of a first plate of the aforementioned device.

The device 14 for storing and supplying cryogenic fluid illustrated can for example contain liquefied hydrogen.

The device 14 comprises a tank 1 delimiting a fluid storage volume. This tank is a thermally insulated cryogenic tank, for example a double-wall tank insulated under vacuum.

The device 14 comprises a drawing-off circuit comprising a duct 4 for drawing off of liquid, with a first end which is connected to the lower part of the tank 1, and a second end which is designed to be connected to a unit for receipt of the fluid.

The drawing-off duct 4 comprises a set of valves 12, 13 and a pump 5.

The device 14 also comprises a system 1 for pressurization of the tank 1 which is provided with a duct 11, 8 for pressurization of fluid which connects the lower and upper parts of the tank 1. The pressurization duct 11, 8 comprises a unit 10, 7 for heating of fluid, which is configured to collect liquid, heat it, and re-inject it into the tank 1.

In the example illustrated, the pressurization system comprises a duct 8 which connects an output of the pump 5 to the upper part of the tank 1, via a heat exchanger 7 (for example with exchange of heat with a fluid circuit 16) and another duct 11 which connects the low and high parts of the tank via an exchanger 10 or heater.

In other words, in order to pressurize the tank, liquid can be drawn off, heated then re-introduced into the tank 1 either via the drawing-off duct 4 provided with the pump 5 and the duct 8, or via a distinct dedicated duct 11. It will be appreciated that the device could comprise a single one of these two pressurization systems.

In its storage volume, the tank 1 comprises a set of plates 2, 3 designed to limit or guide the displacement of fluid in the tank 1. This set of plates comprises a plurality of vertically spaced first plates 2 which extend in a horizontal direction when the tank 1 is in the position of use (the tank 1 is preferably a tank with a generally cylindrical and horizontal form). The vertical spacing of the first plates 2 can be constant or variable, for example increasing (or decreasing) from the top to the bottom of the tank 1. This makes it possible to provide a more efficient labyrinth in the parts with the highest gas temperature gradient at the level of re-injections of hot gas provided by the pressurization system(s).

The set of plates 2, 3 also comprise one, and preferably a plurality of second plates 3 which extend in a vertical direction when the tank 1 is in the position of use, and are preferably connected rigidly to the first plates 2. The second plates 3 are spaced in the horizontal direction.

The set of plates forms labyrinths for the fluid, which limit the re-mixing of the pressurized, under-cooled liquid in the low part, and the overheated gas obtained from the pressurization system in the high part. The liquid thus pressurized will then be admitted into the pump 5 via a drawing-off line 4 in ideal conditions for avoiding cavitation (high available NPSH).

The plates 2, 3 limit the exchanges of masses and energy between the liquid phase and the gaseous phase of the tank 1, in particular in the case of acceleration or inclination of the tank.

As can be seen in FIG. 2, the first plates 2 can extend over most of the horizontal cross-section of the volume of the tank 1, and can be spaced from the wall which forms the tank 1 over at least part of their periphery.

Similarly, the second plate(s) 3 (for example of which there are two, three, four or more) can extend over most of the vertical cross-section of the volume of the tank 1. These second plates 3 can be spaced from the wall which forms the tank 1 over at least part of their periphery.

The plates 2, 3 are preferably constituted by a light and/or thermally insulating material. However, if applicable, the set of plates 2, 3 can act as a structure for strengthening the tank 1, thus making it possible to lighten the tank. The plates 2, 3 can for example be connected mechanically to the tank 1 by welding (if they are made of metal) and/or by clamping and/or by screwing.

The plates 2, 3 can for example be constituted by PTFE, PCTFE, aluminum, and/or any other appropriate material. The thickness of the plates 2, 3 can be between 0.1 mm and 1 mm, for example.

Some or all of the plates 2, 3 can comprise cut-outs for the passage of pipes or other elements, and in particular for the fitting or securing of the horizontal plates 2 in the vertical plates 3.

Bores 15 can be provided in the first horizontal plates 2, in order to permit better circulation of the liquid from the top to the bottom of the tank 1.

The combination of the pressurization system and the set of plates 2, 3 makes it possible to distance the molecule from its saturating vapor point, in particular at the drawing-off point which supplies the pump 5. This continues to be efficient even when the device 14 is on board a mobile device which generates movements of the fluid in the tank. The invention makes it possible to guarantee a better supercharging pressure, thus preventing cavitations in the pump 5. There is therefore a reduction of the risk of loss of priming of the pump intake circuit from the tank 1.

The aforementioned structure thus makes it possible to limit the propagation of calories towards the bottom of the tank 1, but also to limit the movements of liquid, in order to improve the stratification in the tank (and improve the NPSH of the pump).

The invention makes possible improvement of the performance levels of the pump 5 (in particular reduction of the weight and the price), as well as an increase in its service life.

The assembly of the device 14 can be more compact (there is no need to provide a large manometric lift).

The ducts 4 or intake lines can be simplified (lack of a unit to remove the bubbles) and there is little or no risk of bubbles becoming trapped at the valves 12.

The invention also makes possible a reduction of the unbalance (inertia) effects of the tank 1.

1. A device for storing and supplying cryogenic fluid, in particular liquefied hydrogen, comprising a tank (1) delimiting a fluid storage volume, the tank (1) comprising a set of plates (2, 3) which are designed to limit or guide the displacement of fluid in the tank (1), the set of plates comprising a plurality of first plates (2) which are spaced vertically, and extend in a horizontal direction when the tank (1) is in the position of use, characterized in that the set of plates (2, 3) also comprise one or a plurality of second plates (3) which extend in a vertical direction when the tank (1) is in the position of use, and is/are connected to the first plates, the device also comprising a drawing-off circuit comprising a liquid drawing-off duct (4) having a first end which is connected to a lower portion of the tank (1), and a second end which is designed to be connected to a unit for receipt of the fluid, the liquid drawing-off duct (4) comprising a pump (5), the device also comprising a system for pressurization of the tank comprising a duct (11, 8) for pressurization of fluid which connects the lower and upper parts of the tank (1), and being provided with a fluid heating unit (10, 7) which is configured to collect liquid, heat it, and re-inject it into the tank (1), and in that the vertical spacing of the first plates (2) increases from the top to the bottom of the tank (1).

2. The device as claimed in claim 1, characterized in that it comprises a plurality of second plates (3) spaced in the horizontal direction.

3. The device as claimed in claim 1 or 2, characterized in that the first plates (2) extend over most of the horizontal cross-section of the volume of the tank (1), and are spaced from the wall which forms the tank (1) over at least part of their periphery.

4. The device as claimed in any one of claims 1 to 3, characterized in that the second plate(s) (3) extend(s) over most of the vertical cross-section of the volume of the tank (1), and is/are spaced from the wall which forms the tank (1) over at least part of their periphery.

5. The device as claimed in any one of claims 1 to 4, characterized in that the plates (2, 3) have a thickness of between 0.1 mm and 1 mm.

6. The device as claimed in any one of claims 1 to 5, characterized in that plates (2, 3) are composed of at least one of the materials from out of: plastics, PTFE, PCTFE, aluminum, stainless steel, austenitic steel, which in particular are compatible with hydrogen.

7. The device as claimed in any one of claims 1 to 6, characterized in that at least some of the plates (2, 3) comprise orifices (15).

8. The device as claimed in any one of claims 1 to 7, characterized in that the set of plates (2, 3) is secured rigidly on the tank (1), for example by at least one from out of: welding, clamping, screwing.
